(19) United States
(12) Patent Application Publication
(10) Pub. No.: US 2015/0006285 A1
(43) Pub. Date: Jan. 1, 2015

(54) METHOD AND SYSTEM FOR PROVIDING INFORMATION REGARDING ITEMS IN A RETAIL STORE AND COMPUTER PROGRAMS THEREOF

(71) Applicant: Telefonica Digital Espana, S.L.U., Madrid (ES)

(72) Inventors: Francisco Javier Zorzano MIER, Madrid (ES); David del Peral CHICO, Madrid (ES); Carlos Merchán ALVAREZ, Madrid (ES); Gloria Jilie LIN, Madrid (ES); Emily Anne RYAN, Madrid (ES); Raquel Navarro PRIETO, Madrid (ES)

(21) Appl. No.: 13/929,363

(22) Filed: Jun. 27, 2013

(51) Int. Cl. G06Q 30/02; G06Q 30/06

(52) U.S. Cl. CPC G06Q 30/0255; G06Q 30/0631
USPC 705/14.53

(57) ABSTRACT

The method comprising storing in a first database information data of items to be sold in said retail store; identifying from said first database said items that are close to their expiration date; identifying that said user has accessed said retail store by an interaction of said user with said retail store site; and automatically providing to said identified user through an electronic computing device user personalized items recommendations and/or offers including at least one recommended and/or offered item to be close to its expiration date, wherein said personalized items recommendations and/or offers are at least determined based on a consumption profile of said identified user obtained from previous purchased items made by the user and being stored in a second database.

### FIELD OF THE ART

The present invention relates to a method, system, and computer programs for providing information regarding items in a retail store, and, more particularly, to a method, system, and computer programs for grocery store users or other retail store users that connects products in a store in order to improve the eating habits of customers while creating a seamless connection between the online and in-store shopping experience.

### BACKGROUND OF THE INVENTION

Habitual retail stores, in particular stores having items that are perishable like supermarkets, waste a large amount of food. Currently, retail stores or supermarkets try to put these items on sale just before expiring. However, these offers are general and in no way personalized so many shoppers either don't see them or don't feel they are interesting for them.

On a social need level, there is huge shift in societal norms with a clear need for changes in the populations' eating behaviors and a move towards healthier eating. Many customers are not provided with efficient and simple-to-use information regarding eating habits, that are customized precisely to them, for instance the number of calories they should consume in a day a person their age, height, weight, and physical activity.

Current solutions related to the invention can be divided in the following categories:
From the supermarket perspective they try to push in a not personalized way by putting items in discount offers at the stores. While supermarket in general have segmented their clients using loyalty cards, the offers that they are send to their clients in a more personalized way (i.e. through coupons) are not linked with the goal of avoiding wasting food but rather maximizing the profit.
From the Mobile Grocery Shopping Area, the competitors are applications that try to help the users with the shopping list or placing orders, lo locate a supermarket, or to get information about a product. The main features of these type of applications provide are: Sync online cart with the mobile application, ability to make shopping lists before entering the store, location/Store Finder, voice activated trigger to add items to the mobile shopping list/cart, shop from previous orders, ability to scan all of items and leave before getting to the register in order to leave the store quickly, etc.
In addition there are many applications and web pages that provide nutritional information and where users can enter information about what they are eating and get recommendations about what to eat. For instance, MyNetDiary, Fooducate and Lose It!.

A related patent in the field is document U.S. Pat. No. 7,856,368 B2 ‘Methods and systems for providing personalized information to users in a commercial establishment’ which discloses systems and methods for providing a user in a commercial establishment with personalized information, which can include a personalized shopping list, targeted advertisements, health information, nutritional information, promotional offers, offers on sale items, offers on discounted items, manufacturer's coupons, storewide coupons, information on user specific favorite items, and information on user specific staple items.

The problem with the known solutions are that while supermarket in general have segmented their clients using loyalty cards, the offers that they are send to their clients in a more personalized way (i.e. through coupons) are not linked with the goal of avoiding wasting food but rather maximizing the profit.

Moreover, from the Mobile Grocery Shopping Area, the competitors are applications that try to help the users with the shopping list or placing orders, lo locate a supermarket, or to get information about a product. Nevertheless, all of them are targeted to make shopping easier consumers but none of these solutions are aimed to helping with the wasting food as they are not connected with the store stocks.

While there are many mobile applications that make recommendations to user, they don't help at all with the problem of wasting food as they are not associated with the supermarkets.

### DESCRIPTION OF THE INVENTION

It is therefore an object of the invention to provide a solution that gathers real-time health information to inform user purchases while shopping in store and online.

The solution provided uses several inputs that allow knowing which products need to be recommended to each particular user from the ones that are close to expiration date. The user can also perform a scanning of the specific item that wants to purchase. This way the invention can provide specific recommendations to nutritionally complement a particular item in order to make a healthy meal.

In addition, the invention proposes to use the knowledge of the user's previous purchases to generate a nutritional profile that will allow presenting the users offers that will complement their diet preferences in a more general way and it could also provide advertisings to the users, and in general communicate with them, through an electronic computing device such as a mobile phone, a smartphone, a personal digital assistant, a Tablet, or any other mobile computing device and/or through a web portal to inform users both in-store and online. As a result the process connects products in store to improve the eating habits of customers while creating a seamless connection between the online and in-store shopping experience.

In a first aspect, the invention relates to a method for providing information regarding items in a retail store, the retail store including a site electronically accessible by users, the method comprising as commonly in the field: storing in a first database information data of items to be sold in said retail store and providing to a user through an electronic computing device personalized items recommendations and/or offers.

In a characteristic manner and on contrary of the known proposals the method of the first aspect further comprises the following steps: identifying from said first database said items that are close to their expiration date; identifying that said user has accessed said retail store by an interaction of said user with said retail store site; and automatically providing to said identified user through said electronic computing device said provided user personalized items recommendations and/or offers including at least one recommended and/or offered item to be close to its expiration date, wherein said personalized items recommendations and/or offers are at least determined based on a consumption profile of said identified user obtained from previous purchased items made by the user and being stored in a second database.

According to a preferred embodiment, the automatically providing step is performed by displaying said provided user personalized items recommendations and/or offers including at least one recommended and/or offered item to be close to its expiration date on a screen of said electronic computer device.

Preferably the consumption profile is calculated by considering nutritional information of said previous purchased items and is used to generate a nutritional profile of said user by considering personal information of the user regarding their preferences or needs.

The personalized items recommendations and/or offers, according to an embodiment, are provided based on a selection done by the user of at least one item that the user wants to buy when accessing the retail store site.

Moreover, the invention provides nutritional information of the at least one selected item and/or a specific recommendation of another item to nutritionally complement said selected item in order to make a healthy meal.

Preferably, the user access identification is automatically performed immediately when said user accesses the retail store site.

According to another preferred embodiment, the identification of items close to their expiration date is updated in said first database in a customized base depending on each item, wherein said customized base comprises at least a daily, a weekly, a monthly and/or a year base.

In addition, the personalized items recommendations and/or offers can include a reduction in price for the recommended and/or offered items, said reduction at least depending on the closeness to the expiration date of the items or on the customized base of the item.

In a second aspect, the invention relates to a system for providing information regarding items in a retail store, said retail store including a site electronically accessible by users, the system comprising: a first database to store information data of items to be sold in said retail store, and an electronic computing device of a user to at least receive, through output means, personalized items recommendations and/or offers.

In a characteristic manner and on contrary of the known proposals the system further comprises: first computing means associated to said first database configured to identify items that are close to their expiration date in said retail store; second computing means configured to identify that said user has accessed said retail store by an interaction with said retail store site; and processing and communication means configured to automatically provide to said identified user through said electronic computing device said personalized items recommendations and/or offers of said retail store including at least one recommended and/or offered item to be close to its expiration date, wherein said personalized items recommendations and/or offers are at least determined based on a consumption profile of said identified user obtained from previous purchased items made by the user and being stored in a second database.

The system of the second aspect also comprises a third database to store at least nutritional information data of said user. Furthermore, there are provided scanning means related to said electronic computing device configured to allow said user, by means of an object recognition technology, selecting the items the user wants to buy.

According to a preferred embodiment, said output means of the electronic computing device comprises a screen or a display. Alternatively, the output means can include a voice means configured to provide the recommendations and/or offers.

In a third aspect, the invention relates to a computer program product for providing information regarding items in a retail store comprising software code configured to provide when executed in an electronic computing device an automatic selection of personalized items recommendations and/or offers of a retail store based on the expiration date of the items of said retail store and based on a consumption profile of an identified user when interacting with a site of said retail store and obtained from previous purchased items made by said identified user.

According to an embodiment, the computer program of the third aspect can also include software code that is configured to provide said automatic selection of personalized items recommendations and/or offers based on nutritional preferences or needs of said identified user.

The main advantages achieved by the proposed invention include: Avoiding waist of perishable items, especially food items; Recommendations of complementary food items based on in-store selections; Customizable selection based on dietary needs; and providing the user/customer with eating habit profiles that are automatically generated.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is an example of a general flow followed in the present invention, according to an embodiment.

FIG. 2 is an example of the segmentation process used by the present invention in order to provide the personalized items recommendations to the user.

FIGS. 3a, 3b, 3c and 3d show some exemplary embodiments on how the user personalized items recommendations and/or offers are provided in the electronic computing device.

FIG. 4 is an illustrative example of the present invention general architecture when a scanning of an item is performed by the user by means of the electronic computing device, according to an embodiment.

### DETAILED DESCRIPTION OF SEVERAL EMBODIMENTS

The proposed solution for avoiding wasting food in retail stores or supermarkets is advertising products or items close to expiration date food on sale in a very personalized and targeted way, while keeping the best standards in quality.

Preferably, according to an embodiment, the proposed way to provide personalized and targeted advertising is through recommendations and/or offers that help the users to improve their eating patterns to make them healthier.

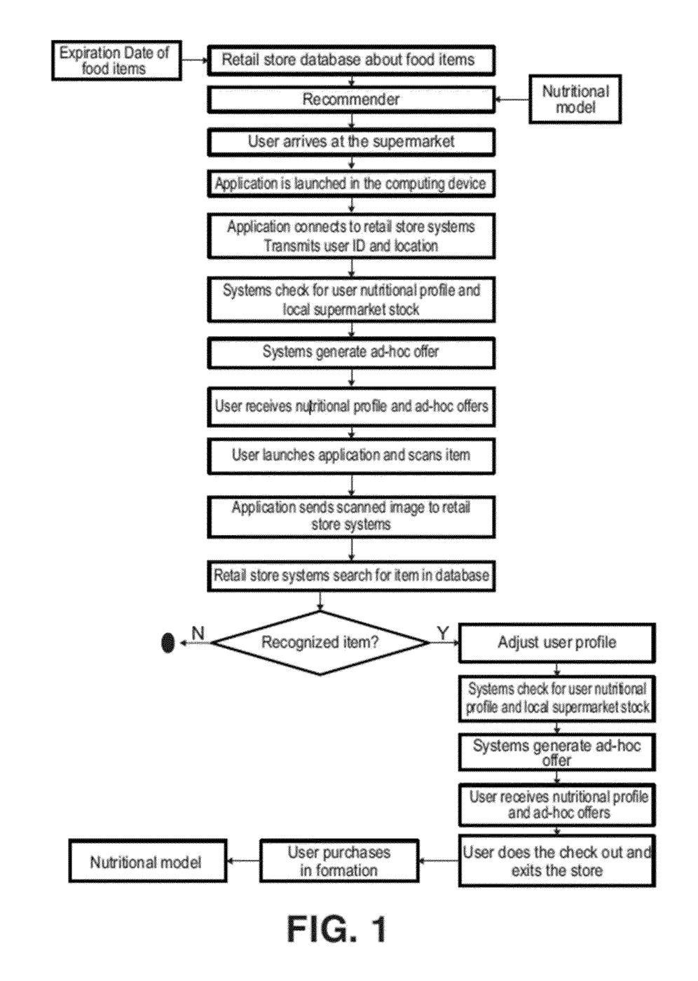

According to an embodiment (FIG. 1) each retail store would have its own updated database (or first database) with the available food items expiration dates identified. Preferably, expiration dates would be identified in a daily bases, although the invention could be customized to other time parameters depending on the item (for instance for spices the expiration day may not be specified by day but by month or even by year). The database will handle different expiration periods.

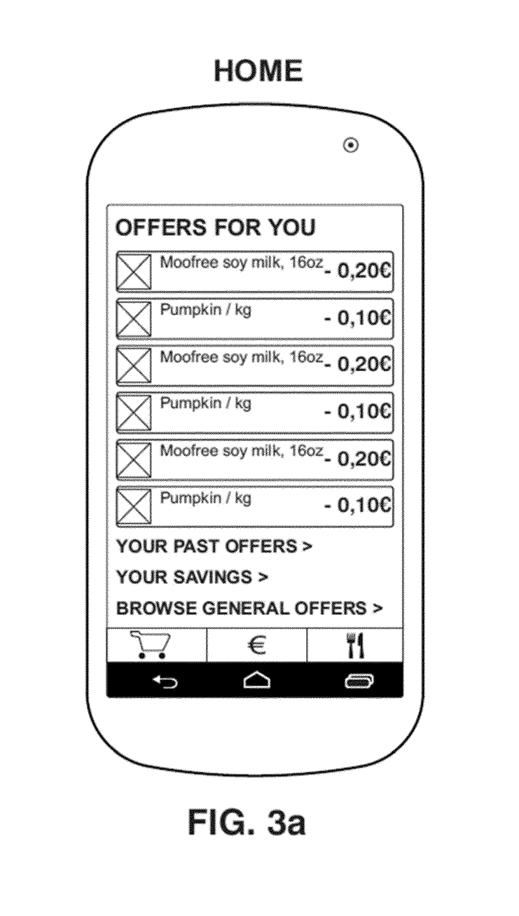

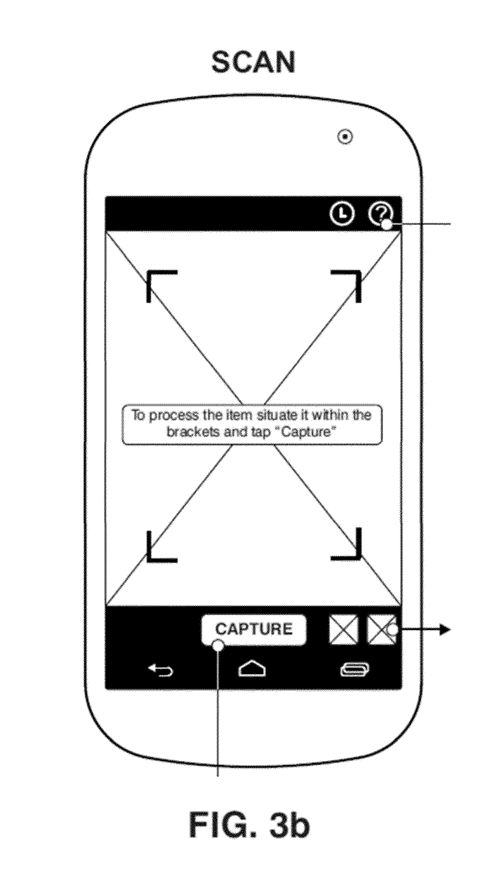

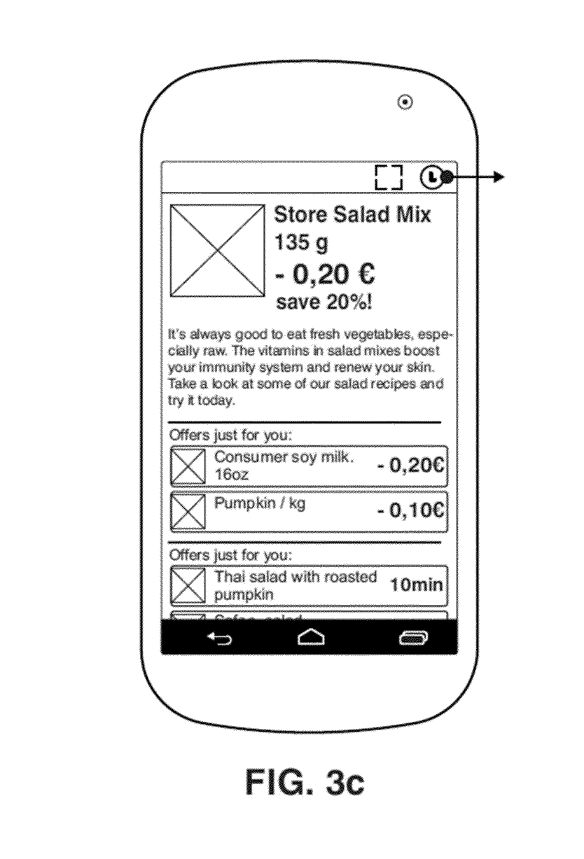

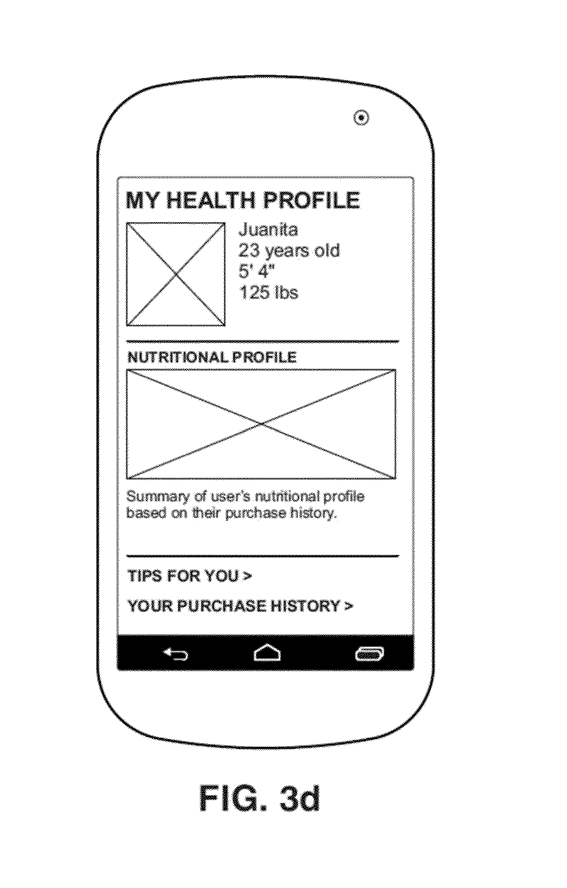

When the user arrives at the retail store, an application or program that can be included in the electronic computing device and operated thereby, could be launched, either by the user or pushed by the electronic computing device as it recognizes, via second computing means, that the user has reached the location of the retail store. As soon as said application is launched it connects the retail store database and user nutritional profile, the user nutritional profile being stored in a third database or nutritional profile database, in order to generate personalized recommendations and/or offers. These recommendations and/or offers are preferably provided or displayed to the users in said electronic computing device (FIG. 3a) via said application.

According to an improvement of the present invention, alternatively, the recommendations and/or offers can be provided to the user by using voice means of said electronic computing device, such as a speaker.

On another hand, an alternative way to receive recommendations and/or offers would be through the users scanning a food item or product that they want to purchase. Every time that the user scans an item the invention provides specific recommendations to nutritionally complement a particular item in order to make a healthy meal. Preferably, the scanning of the item would be done with the electronic computing device mainly through object recognition technology.

When the user finishes the shopping process, their processes to pay and the current purchases are added to a user segmentation model, updating the nutritional profile database.

According to another embodiment, the user can also expand their in-store experience online by means of a web application. Through the web portal users can browse all the online items available for purchase. By clicking on a specific item, the customer will gain the nutritional information for this item as well as how this item fits into their custom nutrition goals. Specialty or featured online items may also include a healthy recipe idea that customers can incorporate into their weekly meal planning.

Users will be able to have a nutritional profile and input custom goals, i.e. Vegetarian Diet, Low Sodium, Weight Loss, etc. They will have access to this nutritional profile through the web portal and have updated nutritional information based on their most recent in-store and online purchases. Users will have a fast and easy way to see how they are working towards making healthier choices.

Moreover, to complement the in-store experience online customers will be able to create a shopping list online for use in the web or accessible in-store. They will also be able to search for healthy recipes on the site and receive suggested menus based on their most recent purchases and items in their online basket. To make shopping on the website even easier the customers will have access their previous shopping lists and purchases and be able to duplicate their earlier lists.

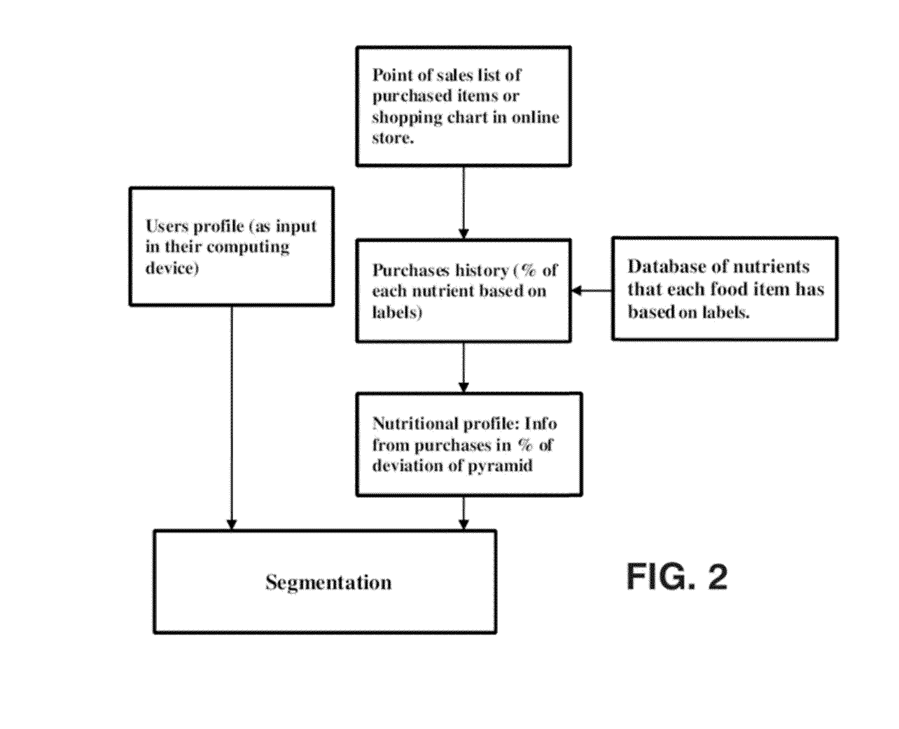

As a central piece of the solution, the recommender unit is responsible for at least providing the final user with a list of the offers of items to buy in a discount price as well as presenting the user recipes that include this item and the related items that the user could buy that will complete a recipe. The following process describes the inputs and information flow into the recommender unit, as described in FIG. 2.

First the invention calculates the user profile. The user profile generates a database entrée for each of the users that have downloaded the application. The first entrée in the database is a parameter from 1 to 5 that is filled by the user's the first time they use the application. The first time the users open the application they are prompt with the following questions:

1. “In a scale from 1 to 5 tell us how motivated you fell to lose weight”

2. “In a scale from 1 to 5 tell us how motivated you fell to save money”

3. “Normally I create a shopping list before shopping”: yes/no answer possibilities

The database entrée from each user can also have all the available information from the supermarket about the user like the marital status, health concerns, allergies, etc. if the user has provided this information to the supermarket before.

In parallel, the invention calculates the purchased history, which takes as an input the name of the items that the user's purchases at the point of the sales (or the shopping list in the online chart if the shopping is done in an online store). This module connects to a database of information about the nutrients (carbon hydrates, sugar, salt, etc.) of each food item, which will provide the exact number for each of the nutrients of each food item. A purchases history module then sums all the nutrients of the food item that the user has purchased and creates the purchase history. The purchase history or consumption profile of said user is stored in a second database, where all the shopping the user does with the supermarket is kept.

In a characteristic manner, the nutritional profile uses as an input the information from the User Profile and the Purchases History. The nutritional profile generates a vector for each user which is calculated with the formula below:

Nutritional profile=sum of % of deviation of recommended intake for each of the food items nutrients (according to OMS).

This nutritional profile and the user's profile will be used to create user segmentation in a segmentation unit. The segmentation process output is a combination of these entrees.

According to an embodiment, the segmentation unit can allocate users into four categories.
category A: I really want to lose weight if Answer to motivation to lose weight is > or = to 3 and the deviation is higher than 20%.
category B: Parents that need reassurance that their children are eating health if Answer to motivation to lose weight is higher or equal to 2, the database of the user profile shows that the user have children and the deviation is lower than 20%.
category C: I want to save money if Answer to motivation to save money is higher to the answer to the motivation to lose weight and the deviation is higher than 20%.
category D: I really want to lose weight if Answer to normally I create a shopping list is NO and the deviation is lower that 20%.

Generally, the output of the segmentation process would be used in the recommendations made to the users. In order to motivate the users to take the recommendations, the invention will propose a reduction in price for the recommended items. The % of reduction in the price preferably will depend on the closeness to the expiring date the item is and in the type of food item: A: normally consumed in 1 week; B: normally consumed in 1 month; C: normally consumed in 2 months; D: other consumer time.

As mentioned before, the user can select by itself the items or products that their want to buy by means of using the scanning function. Normally, the scanning function operates by taking a picture of the item as can be seen in FIG. 3b. Once the item is scanned and processed, the item and a possible recommendation will show up on the screen of the electronic computing device. Users will also see related offers and related recipes for that scanned item (FIG. 3c).

The user nutritional profile can be also displayed on the screen of the electronic computing device as can be seen in FIG. 3d. The user can see their nutritional profile based on their past purchases as well as tips to improve their profile.

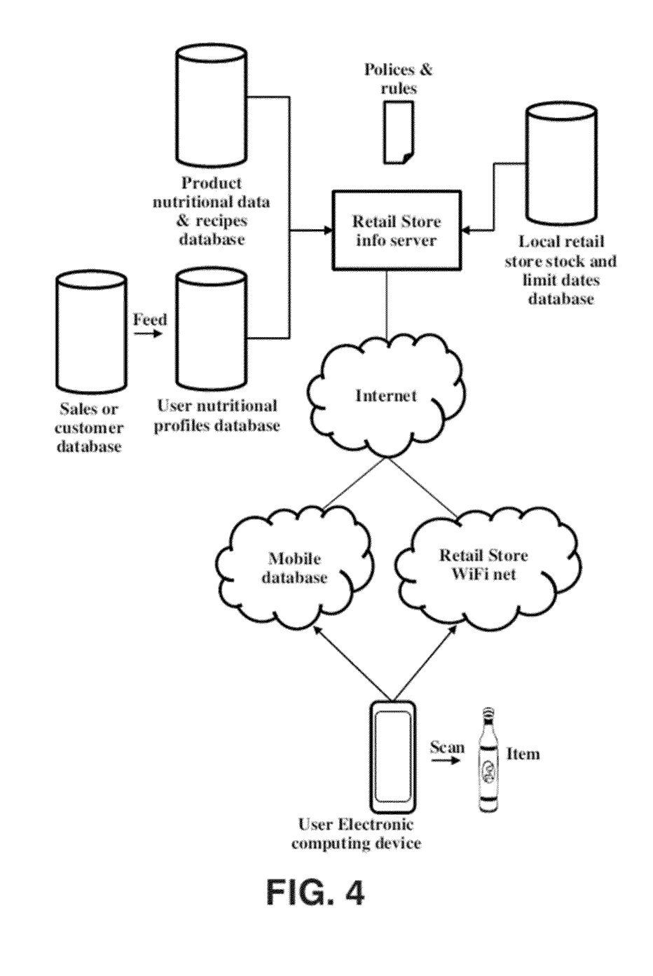

In reference to FIG. 4, when the user has scanned an item, the electronic computing device connects to the Internet to access information and send images of the products. This connection can be achieved either by means of a mobile network, this connectivity is nearly ubiquitous and is made automatically, or by means of a retail store or supermarket WiFi connection. This connection is faster than the mobile connection, should have no cost for the user and should be available all over the retail store (while mobile connection can have problems and slower bandwidth in closed spaces). On the down side, users have to configure explicitly the connection.

The application connects to a service, deployed in an Internet server of the retail store. Although proprietary protocols can be used to connect application and service, the best solution is to use HTTP requests on TCP/IP connections. This kind of connectivity runs on most transport networks, and there are many tools supporting them. The full retail store chain shares a common information server. Then, the retail store information server gets requests from the user electronic computing device and sends them: User nutritional profile; Product identification (when the user computing device sends an image of an item); Item information; General and special offers and recipes.

The service information can be accessed also by users through the retail store chain web server. So the retail store web server system will access the system information server.

One of the requests sent by the user is an image of an item to be recognized. The retail store information server will find the identification of the product in the image. This functionality is executed in a specific software system, called a “recognition engine”. This engine can be deployed typically in two ways: As a part in the retail store information service, as an external service, employed in “Software as a Service” manner. The recognition engine contains a database of items images. User photos are compared with special algorithms to this database. If a match is found the recognition engine returns the item identification.

Finally, the information server will resort to a series of rules in order to determine: which items should recommend to every user and which discounts to offer. These rules generally will be based in: User nutritional needs; User preferences, as discovered through previous sales; Supermarket stock; Caducity dates of stock; Products analyzed by the customer (photographing them); or other company policies (such as testing or launching a new product).

The Policies and rules can be stored in a software system in three ways: Hardcoded in the software code; Written in accessible files that the administrators change and the software reads periodically or when restarted or hold in a specific subsystem for rule management and execution called a “rules engine”.

Although the present invention has been as described in detail with reference to its preferred embodiments, it should be readily apparent to those skilled in the art that changes and modifications in form and details can be made without departing from the scope and spirit of this disclosure.

1. A method for providing information regarding items in a retail store, said retail store including a site electronically accessible by users, said method comprising:
storing in a first database information data of items to be sold in said retail store;
providing to a user through an electronic computing device personalized items recommendations and/or offers, wherein the method further comprises the following steps:
identifying from said first database said items that are close to their expiration date;
identifying that said user has accessed said retail store by an interaction of said user with said retail store site; and
automatically providing to said identified user through said electronic computing device said provided user personalized items recommendations and/or offers including at least one recommended and/or offered item to be close to its expiration date, wherein said personalized items recommendations and/or offers are at least determined based on a consumption profile of said identified user obtained from previous purchased items made by the user and being stored in a second database.

2. A method according to claim 1, wherein said automatically providing step is performed by displaying said provided user personalized items recommendations and/or offers including at least one recommended and/or offered item to be close to its expiration date on a screen of said electronic computer device.

3. A method according to claim 1, wherein said consumption profile is calculated by considering nutritional information of said previous purchased items.

4. A method according to claim 3, comprising using said consumption profile to generate a nutritional profile of said user, said nutritional profile being further stored in a third database.

5. A method according to claim 4, further comprising generating said user nutritional profile by considering personal information of said user regarding their preferences or needs.

6. A method according to claim 1, further comprising providing said personalized items recommendations and/or offers based on a selection done by said user of at least one item that the user wants to buy when accessing the retail store site.

7. A method according to claim 6, further comprising providing nutritional information of said at least one selected item and/or providing a specific recommendation of another item to nutritionally complement said selected item in order to make a healthy meal.

8. A method according to claim 1, wherein said user access identification is automatically performed immediately when said user accesses the retail store site.

9. A method according to claim 1, wherein said identification of items close to their expiration date is updated in said first database in a customized base depending on each item.

10. A method according to claim 9, wherein said customized base comprises at least a daily, a weekly, a monthly and/or a year base.

11. A method according to claim 9, wherein the personalized items recommendations and/or offers comprises a reduction in price for the recommended and/or offered items, said reduction at least depending on the closeness to the expiration date of the items or on the customized base of the item.

12. A system for providing information regarding items in a retail store, said retail store including a site electronically accessible by users, comprising:
a first database to store information data of items to be sold in said retail store, and
an electronic computing device of a user to at least receive, through output
means, personalized items recommendations and/or offers, wherein the system further comprises:
first computing means associated to said first database configured to identify items that are close to their expiration date in said retail store;
second computing means configured to identify that said user has accessed said retail store by an interaction with said retail store site; and
processing and communication means configured to automatically provide to said identified user through said electronic computing device said personalized items recommendations and/or offers of said retail store including at least one recommended and/or offered item to be close to its expiration date, wherein said personalized items recommendations and/or offers are at least determined based on a consumption profile of said identified user obtained from previous purchased items made by the user and being stored in a second database.

13. A system according to claim 11, further comprising a third database to store at least nutritional information data of said user.

14. A system according to claim 13, further comprising scanning means related to said electronic computing device configured to allow said user, by means of an object recognition technology, selecting the items the user wants to buy.

15. A system according to claim 12, wherein said output means comprises a screen.

16. A computer program product for providing information regarding items in a retail store comprising software code configured to provide when executed in an electronic computing device an automatic selection of personalized items recommendations and/or offers of a retail store based on the expiration date of the items of said retail store and based on a consumption profile of an identified user when interacting with a site of said retail store and obtained from previous purchased items made by said identified user.

17. A computer program product according to claim 16, further comprising software code that is configured to provide said automatic selection of personalized items recommendations and/or offers based on nutritional preferences or needs of said identified user.
